(19) United States
(12) Patent Application Publication
(10) Pub. No.: US 2022/0177720 A1
(43) Pub. Date: Jun. 9, 2022

(54) CONDUCTIVE FILM FORMATION

(71) Applicant: Cambrios Film Solutions Corporation, Tortola (VG)

(72) Inventors: Pierre-Marc ALLEMAND, Santa Clara, CA (US); Haixia DAI, Pleasanton, CA (US); Michael Andrew SPAID, Mountain View, CA (US)

(21) Appl. No.: 17/600,749

(22) PCT Filed: Apr. 1, 2020
(86) PCT No.: PCT/US2020/026062

§ 371 Date: Oct. 1, 2021

Related U.S. Application Data
(60) Provisional application No. 62/828,684, filed on Apr. 3, 2019.

(51) Int. Cl. C09D 11/52; C09D 11/037; C09D 7/20; C09D 101/04; C09D 167/02; H01B 1/22; B05D 7/00

(52) U.S. Cl. CPC C09D 11/52; C09D 11/037; C09D 7/20; B05D 7/544; C09D 167/02; H01B 1/22; C09D 101/04

(57) ABSTRACT

A method of forming a conductive film. The method includes applying an ink onto a substrate. The ink includes a plurality of nanostructures formed from an electrically-conductive material and a polymer binder. The method includes drying the ink on the substrate. The method includes applying an overcoat material solution onto the dried ink. The overcoat solution includes at least some solvent suitable to provide at least some solubility of the binder. Also, a conductive film that includes a substrate, a matrix on the substrate, and a plurality of nanostructures within the matrix. The matrix is provided as a resultant of a polymer binder present within an ink that carried the nanostructures that was applied and dried upon the substrate, a dried/cured overcoat material that that was applied on the dried ink layer in the form of a coating solution that included a polymer and at least some solvent to provide at least some solubility of the binder, with the binder being at least partially dissolved.

### RELATED APPLICATION

This application claims priority to U.S. Provisional Application Ser. No. 62/828,684, titled “CONDUCTIVE FILM FORMATION” and filed on Apr. 3, 2019, which is incorporated herein by reference.

### FIELD

This application relates generally to a transparent conductive film comprising conductive nanowires disposed in a matrix layer, and a method of forming a transparent conductive film with a controlled position of conductive nanostructures in a matrix layer.

### BACKGROUND

Conventional conductive films that exhibit high visible light transmittance and exhibit electrical conductivity are commonly used as transparent electrodes. Recently transparent conductive films made from percolated silver nanostructures have attracted great interest due to their high transparency, high electrical conductivity, and superior stretchability. Such electrodes can be used in the construction of liquid crystal displays, touch panels, electroluminescent devices, thin film solar cells, and other devices.

Silver nanowires (AgNWs) are an example nanostructure. An example application for AgNWs is within transparent conductor (TC) layers in electronic devices, such as touch panels, photovoltaic cells, flat liquid crystal displays (LCD), organic light emitting diodes (OLED), etc. Various technologies have produced TCs based on one or more conductive media such as conductive nanostructures. Generally, the conductive nanostructures form a percolating network with long-range interconnectivity.

Typically, silver nanowire transparent conductive films consist of a clear substrate coated with percolated silver nanowires in a polymer matrix. Depending on the particular application in which the conductive films are to be utilized, however, the physical configuration of the conductive silver nanowire layer can vary in the polymer matrix. For example, the position of conductive nanowires, as example nanostructures, at different locations within the polymer matrix can impart different properties on the conductive film, possibly for one or more specific applications.

### BRIEF SUMMARY

According to an aspect, the subject disclosure provides a method of forming a conductive film. The method includes applying an ink onto a substrate. The ink includes a plurality of nanostructures formed from an electrically-conductive material and a polymer binder. The method includes drying the ink on the substrate. The method includes applying a coating solution of overcoat material onto the dried ink. The overcoat coating solution includes a polymer and at least some solvent suitable to provide at least some solubility of the binder. The method includes drying and curing the overcoat.

According to an aspect, the subject disclosure provides a conductive film that includes a substrate, a matrix on the substrate, and a plurality of nanostructures formed from an electrically-conductive material located within the matrix. The matrix is provided as a resultant of a polymer binder present within an ink that carried the nanostructures that was applied and dried upon the substrate, a dried/cured overcoat material that was applied on the dried ink layer in the form of a coating solution that included a polymer and at least some solvent to provide at least some solubility of the binder, with the binder being at least partially dissolved.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

The disclosed subject matter may take physical form in certain parts and arrangement of parts, embodiments of which will be described in detail in this specification and illustrated in the accompanying drawings which form a part hereof and wherein:

FIG. 1 shows a schematic cross section assembly of a transparent electrically-conductive film and also schematically shows an example method of making the transparent conductive film, with conductive nanowires arranged at three possible examples of different depths within a polymer matrix as a result of different solubility levels of a binder in an overcoat solvent.

FIGS. 2A-2C show SEM images of silver nanowire position in a Z axis (see arrowhead added to each image), located: A) close to a substrate; B) in the middle of a matrix; and C) close to top surface of the matrix and thus away from the substrate.

FIG. 3 is a flowchart of an example method in accordance with the present disclosure.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

Certain terminology is used herein for convenience only and is not to be taken as a limitation on the disclosed subject matter. Relative language used herein is best understood with reference to the drawings, in which like numerals are used to identify like or similar items. Further, in the drawings, certain features may be shown in somewhat schematic form.

The following subject matter may be embodied in a variety of different forms, such as methods, devices, components, and/or systems. Accordingly, this subject matter is not intended to be construed as limited to any illustrative embodiments set forth herein as examples. Rather, the embodiments are provided herein merely to be illustrative.

Provided herein is a method of adjusting position of conductive nanostructures during preparation of a conductive film. As used herein, “conductive nanostructures” or “nanostructures” generally refer to electrically conductive nano-sized structures, at least one dimension of which is less than 500 nm, or less than 250 nm, 100 nm, 50 nm or 25 nm, for example. Typically, the nanostructures are made of a metallic material, such as an elemental metal (e.g., transition metals) or a metal compound (e.g., metal oxide). The metallic material can also be a bimetallic material or a metal alloy, which comprises two or more types of metal. Suitable metals include, but are not limited to, silver, gold, copper, nickel, gold-plated silver, platinum and palladium.

The nanostructures can be of any shape or geometry. The morphology of a given nanostructure can be defined in a simplified fashion by its aspect ratio, which is the ratio of the length over the diameter of the nanostructure. For instance, certain nanostructures are isotropically shaped (i.e., aspect ratio=1). Typical isotropic nanostructures include nanoparticles. In preferred embodiments, the nanostructures are anisotropically shaped (i.e., aspect ratio≠1). The anisotropic nanostructure typically has a longitudinal axis along its length. Exemplary anisotropic nanostructures include nanowires, nanorods, nanotubes, etc. To be clear, nanostructures includes nanowires, but is not limited to nanowires.

The nanostructures can be solid or hollow. Solid nanostructures include, for example, nanoparticles, nanorods and nanowires. Focusing upon nanowires, nanowires typically refers to long, thin nanostructures having aspect ratios of greater than 10, preferably greater than 50, and more preferably greater than 100. Typically, the nanowires are more than 500 nm, more than 1 μm, or more than 10 μm long. “Nanorods” are typically short and wide anisotropic nanostructures that have aspect ratios of no more than 10. Although the present disclosure is applicable to any type of nanostructure, some discussions herein with be directed to silver nanowires (“AgNWs” or abbreviated simply as “NWs”) will be described as an example.

A transparent conductive film can be formed to include a percolating network of electrically-conductive nanowires as example nanostructures. The film can include at least 2-layers, which can be coated in one or two passes depending on the coating system. First, a nanowire ink, as an example nanostructure ink, is coated onto a substrate such as a plastic film. The ink includes a polymeric binder in which a plurality of nanowires formed from an electrically-conductive material are suspended after the solvent is removed in incremental stages as the ink on the substrate is passed through one, or a series of ovens at increasing temperatures.

A protective polymer layer or “overcoat material” is coated on top of the interconnected silver nanowire layer containing silver nanowires and binder to render the film mechanically robust and reliable during environmental exposure. Overcoat material coating solution includes at least a polymer and a solvent. Overcoat coating solution is coated on top of the interconnected silver nanowire layer containing silver nanowires and binder, and then followed by drying to remove the solvent and curing to crosslink the polymer. In the resulting transparent conductive film the nanowires are surrounded in a matrix of materials which include both binder and overcoat materials. Depending on the application, the location of nanowires inside the matrix in a direction along the Z axis (e.g., a depth direction of the matrix) can be controlled based on the solubility of the binder material by a solvent in the overcoat coating solution. For example, the nanowires (at least some, optionally at least a plurality, or at least a majority of the nanowires) can be located, close to the substrate, in the middle of the matrix, or close to the top surface of the matrix. The extent of interlayer mixing and the final vertical position of the nanowires can vary depending on the overcoat condition.

Although the scope of the present disclosure is not so limited, specific examples of the methods and films will be described below with reference to nanowires formed from silver. Other examples are provided for the binder, the substrate, the overcoat material, possibly other structures and possibly other nanostructures. However, the present disclosure is not limited to the specific examples described.

The conductive nanowires can include strands of a crystalline metal suspended in a fluid medium such as a substantially-transparent polymeric binder or other suitable liquid, for example. The strands can be formed of any metal such as silver, selected for its high electrical conductivity. The strands can be elongated structures, having an average diameter from about ten (10 nm) nanometers to about one hundred (100 nm) nanometers, and an average length of at least one (1 μm) micrometer. When the conductive nanowire material with the suspended metal strands is coated onto a surface, the resulting film includes a network of highly-conductive metal nanowires that is substantially transparent (e.g., transmits a majority of light imparted thereon when observed by a human observer). The nanowire network also percolates over the extent of the network, to form an electrically-conductive pathway.

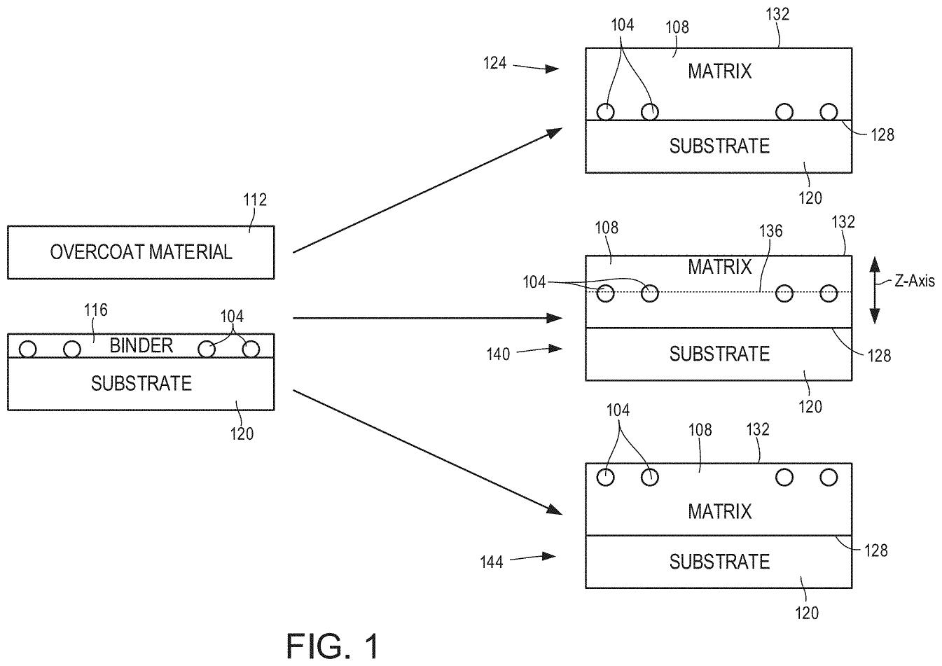

This disclosure describes methods to control the nanowire 104 (FIG. 1), as an example nanostructure, position in a depth direction (the Z-axis in FIG. 1) within a matrix 108 formed from at least an overcoat material 112, optionally combined with material forming a binder 116, described below. In addition to the solubility of the binder 116 in the overcoat material 112 coating solution, there are other factors affecting the position of the silver nanowires 104, such as binder properties, overcoat solvent properties, drying time, wet film thickness, etc. Illustrative embodiments of controlling nanowire 104 position in a depth direction within the matrix 108 are described below.

It is to be appreciated that FIG. 1 shows a schematic cross section assembly of a transparent electrically-conductive film and also schematically shows an example method of making the transparent conductive film. Specifically, three different example resultant films 124, 140 and 144 are shown. The three arrowheads extending generally from the left to the right in FIG. 1 represent the method with three different variations and thus three different resultant films 124, 140 and 144. The variations can include variation of an ability of the coating solution of overcoat material 112 to dissolve the binder 116.

For the three different example resultant films 124, 140 and 144, the conductive nanowires are arranged at three possible examples of different depths within a polymer matrix as a result of different solubility levels of a binder in an overcoat solvent. It is to be appreciated that the three examples are only examples and are not limitations upon the present disclosure. Many different resultant films are possible, contemplated and are within this present disclosure.

Focusing back to FIG. 1, the plurality of nanowires 104 can be positioned within the matrix 108 adjacent to a substrate 120 as shown in the film 124 (the first example resultant film) of FIG. 1. To be considered adjacent to the substrate 120, the nanowires 104 are positioned along the Z-axis closer to an interface 128 between the matrix 108 and the substrate 120 than to a top surface 132 of the matrix 108. According to other embodiments, to be considered adjacent to the substrate 120, the nanowires 104 are positioned along the Z-axis closer to the interface 128 than to a central region of the matrix 108, which is centered on a centerline 136 of the matrix 108 of the film 140 in FIG. 1.

To form the film 124, an ink including silver nanowires 104 and binder 116 in which the silver nanowires are suspended is coated onto a substrate 120 formed from a plastic or other suitably-rigid material. In addition to the binder 116, the coated silver nanowire ink can also optionally include one or more polymer viscosity modifiers, surfactants, solvents, and/or other additives in combination with purified silver nanowires 104. After coating the substrate 120 with the silver nanowire ink with any optional additives, the silver nanowire ink is dried to substantially surround the silver nanowires 104 in the binder 116. Since the loading of the binder 116 is small, most or all of the nanowires 104 are disposed very close to substrate 120 within the binder layer.

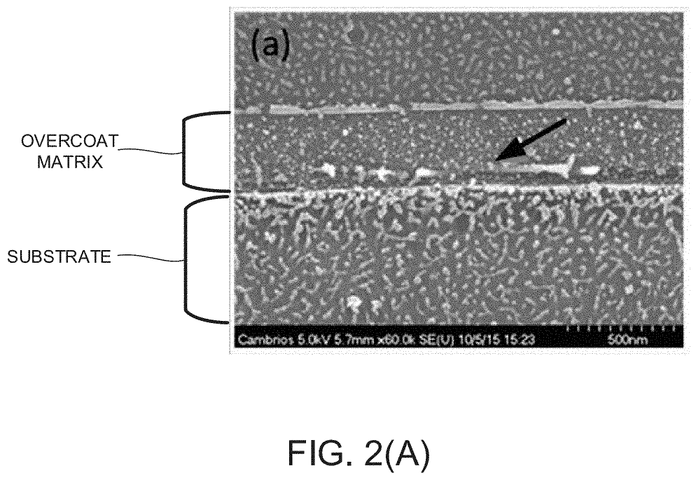

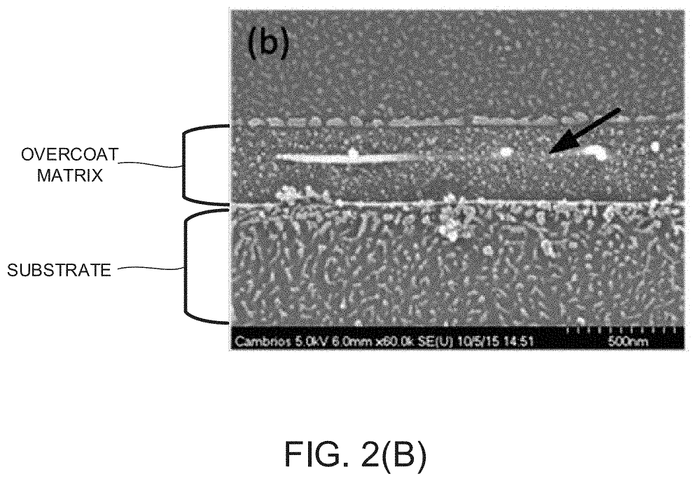

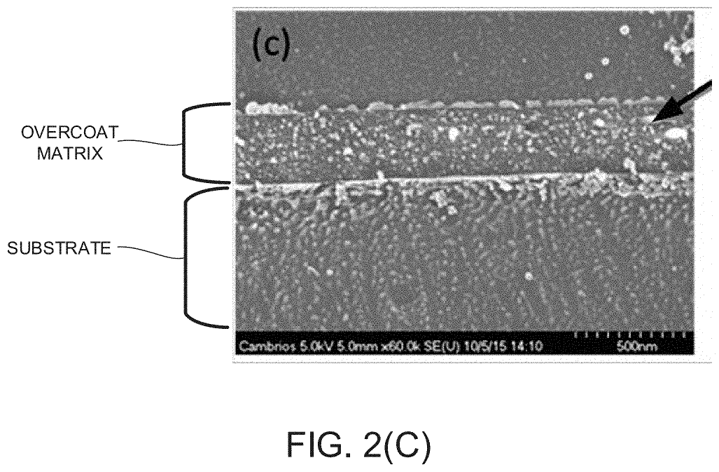

After the silver nanowire ink is dried, a coating solution of overcoat material 112 is coated on top of the percolated silver nanowire layer containing silver nanowires and binder material, optionally in combination with a polymer in a pure or mixed solvent. During coating of the silver nanowire layer with the coating solution of overcoat material 112, the nanowires 104 will remain on, or adjacent to the substrate 120 if the binder 116 is insoluble, or has only limited solubility in the solvent of the coating solution of overcoat material 112. For example, a water-soluble polymer hydroxypropyl methylcellulose (HPMC) can be used as the binder 116, and a non-polar or polar aprotic solvent such as propylene glycol methyl ether acetate (PGMEA) and methyl ethyl ketone (MEK) can be used as a solvent forming a portion of the coating solution of overcoat material 112. The resulting nanowire network stayed close to a substrate 120 formed from polyethylene terephthalate (PET) after coating in two steps: (i) nanowire ink coating on PET substrate first, followed by drying/baking in a series of ovens with temperature ranging from 40° C. to 120° C.; (ii) coating solution of overcoat material 112 coating on the dried nanowire layer, followed by drying/curing of overcoat material 112. FIG. 2A is an SEM image showing the resulting nanowire position adjacent to a PET substrate 120 (e.g., see the arrowhead pointing to the nanowire position). Such could be example representations of the example film 124 of FIG. 1. In addition, the binder/nanowire layer can be crosslinked. The crosslinked binder layer is insoluble in the coating solution of overcoat materials so the nanowire layer stays close to the substrate surface after coating overcoat materials.

The nanowires 104 can be arranged in the middle or top of the matrix 108 as a result of selecting a binder 116 material that is at least soluble, or at least freely soluble, and optionally very soluble in the coating solution of overcoat material 112, as shown in films 140 and 144 of FIG. 1. Solubilities are defined below in Table 1.

TABLE 1
SOLUBILITY LEVELS

| | Parts of solvent per 1 part |
|---|---|
| Descriptive Level | of solute (material) |
| Very Soluble | Less than 1 |
| Freely Soluble | From 1 to 10 |
| Soluble | From 10 to 30 |
| Sparingly Soluble | From 30 to 100 |
| Slightly Soluble | From 100 to 1000 |
| Very Slightly Soluble | From 1000 to 10,000 |
| Practically Insoluble, or Insoluble | More than 10,000 |

For example, during coating with the overcoat material 112, the nanowires 104 will “float” or otherwise migrate into the middle region of the matrix 108, adjacent to the centerline 136, if the binder 116 is completely soluble in the solvent(s) of the coating solution of overcoat material 112. For example, a water-soluble polymer hydroxypropyl methylcellulose (HPMC) can be used as a binder material, and a polar protic solvent such as isopropyl alcohol (IPA) can be used as an overcoat solvent. With such materials, the binder dissolves into the IPA and floats adjacent to the middle of the matrix 108 after application of the coating solution of overcoat material 112 and subsequent drying/curing. Depending on the adhesion of the binder to the substrate 120, the nanowires stay either in the middle or adjacent to the top surface 132 of the matrix 108. FIGS. 2B and 2C show SEM images of nanowire position in the middle and in the top of the overcoat/binder matrix (e.g., see the respective arrowheads pointing to the respective nanowire positions). Such could be example representations of example films 140 and 144 of FIG. 1.

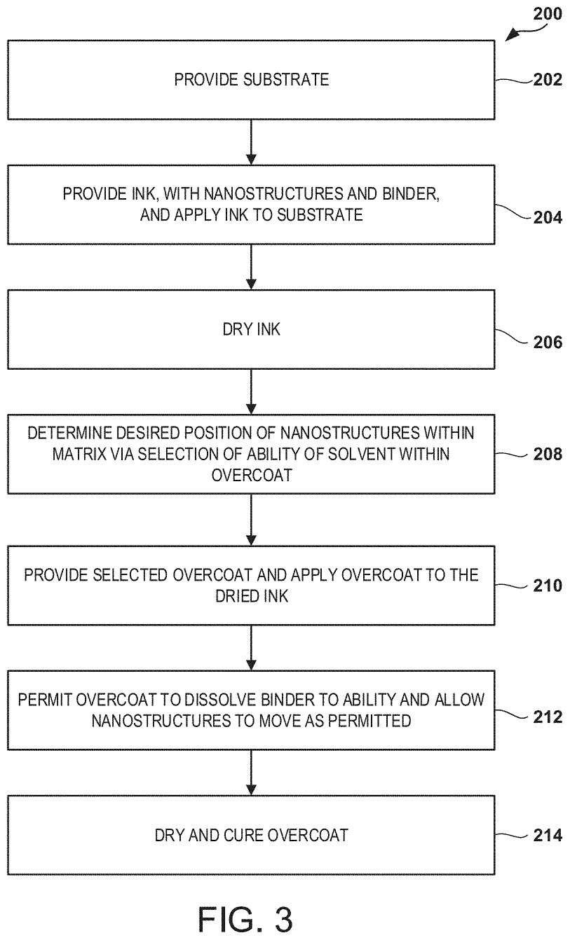

FIG. 3, is a flowchart of an example method 200 in accordance with the present disclosure. It is to be appreciated that the example method is only an example and is not a specific limitation upon the present disclosure. It is to be appreciated that the steps shown within the example method 200 need not be performed in the shown sequence, e.g., some steps may be performed simultaneously or in a different order.

The method 200 begins at step 202 a substrate is provided. At step 204, an ink is provided. The ink includes nanostructures and binder. The ink is applied to the substrate. At step 206, the ink is dried, at least partially.

At step 208 a determination of a desired position of nanostructures within matrix via selection of ability of solvent within overcoat solution is made. Such can include selection of solubility. In other words, the overcoat solution, with desired dissolving ability is selected. At step 210, the coating solution of the selected overcoat is provided and applied to the dried ink. At step 212, the overcoat solution is permitted to dissolve binder. Such also allows the nanostructures to move, e.g., “float” as permitted. At step 214, the overcoat is dried and then followed by curing to form an overcoat/binder matrix on a substrate with a plurality of nanostructures located in the desired position in the Z axis within the matrix.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or.” In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes,” “having,” “has,” “with,” and/or variants thereof are used in either the detailed description or the claims, such terms are intended to be inclusive in a manner similar to the term “comprising.”

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described herein should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A method of forming a conductive film, the method comprising:
applying an ink onto a substrate, the ink comprising a plurality of nanostructures formed from an electrically-conductive material and a polymer binder;
drying the ink on the substrate;
applying a coating solution of overcoat material onto the dried ink, wherein the overcoat material comprises a polymer and at least some solvent suitable to provide at least some solubility of the polymer binder; and
drying and curing the coating solution,
wherein the overcoat material and the polymer binder together provide a matrix upon the substrate within which the nanostructures are located, and the nanostructures are at a depth within the matrix that is established by a solubility of the polymer binder by the coating solution.

2. (canceled)

3. The method of claim 1, wherein the nanostructures provide a percolating network within the matrix.

4. The method of claim 3, wherein the percolating network of nanostructures is spaced at a distance from the substrate in a depth direction along a Z-axis within the matrix.

5. The method of claim 1, including adjusting an ability of the at least some solvent in the coating solution to dissolve the polymer binder.

6. The method of claim 5, including permitting the nanostructures to move a depth direction along a Z-axis within the matrix away from the substrate a distance that is related to an ability of the at least some solvent in the coating solution to dissolve the polymer binder.

7. (canceled)

8. The method of claim 1, wherein the polymer binder is substantially insoluble in the coating solution.

9. The method of claim 1, wherein the nanostructures are arranged closer to the substrate in a depth direction of the matrix than to an opposite surface of the matrix in the depth direction.

10. The method of claim 1, wherein the nanostructures are arranged at a location in a depth direction separated from the substrate by at least a distance suitable to position the nanostructures within a central region of the matrix in the depth direction of the matrix.

11. The method of claim 1, wherein the polymer binder is at least freely soluble in the coating solution.

12. The method of claim 1, wherein the nanostructures are arranged at a location in a depth direction separated from the substrate by at least a distance suitable to position the nanostructures adjacent to an opposite surface of the matrix away from the substrate in the depth direction of the matrix.

13. The method of claim 1 further comprising crosslinking the dried ink before applying the coating solution.

14. A conductive film comprising:
a substrate;
a matrix on the substrate; and
a plurality of nanostructures formed from an electrically-conductive material located within the matrix,
wherein the matrix is provided as a resultant of a polymer binder present within an ink that carried the nanostructures that was applied and dried upon the substrate, and a dried/cured overcoat material that was applied on the dried ink in the form of a coating solution that comprised a polymer and at least some solvent to provide at least some solubility of the polymer binder, with the polymer binder being at least partially dissolved, and
wherein a location of the nanostructures within the matrix is provided by movement in a depth direction along a Z-axis within the matrix away from the substrate a distance that is positively related to an ability of the at least some solvent in the coating solution to dissolve the polymer binder.

15. The film of claim 14, wherein the nanostructures provide a percolating network within the matrix.

16. The film of claim 15, wherein the percolating network of nanostructures is spaced at a distance from the substrate in the depth direction along the Z-axis within the matrix.

17. (canceled)

18. The film of claim 14, wherein the matrix is provided with the polymer binder having been substantially insoluble in the coating solution.

19. The film of claim 14, wherein the nanostructures are arranged closer to the substrate in the depth direction of the matrix than to an opposite surface of the matrix in the depth direction.

20. The film of claim 14, wherein the nanostructures are arranged at a location in the depth direction separated from the substrate by at least a distance suitable to position the nanostructures adjacent to an opposite surface of the matrix away from the substrate in the depth direction of the matrix.
